(19) United States
(12) Patent Application Publication
(10) Pub. No.: US 2013/0196297 A1
(43) Pub. Date: Aug. 1, 2013

(54) INTERACTIVE SHOPPING - HEALTH & WELLNESS

(71) Applicant: Yasir Anwar, Fremont, CA (US)

(72) Inventor: Yasir Anwar, Fremont, CA (US)

(21) Appl. No.: 13/362,302

(22) Filed: Jan. 31, 2012

(51) Int. Cl. G09B 19/00

(52) U.S. Cl. 434/236

(57) ABSTRACT

Various aspects are directed to providing health and wellness guidance and support both in social settings and through other on-line platforms. The on-line platforms can integrate health and wellness goal definition, activity tracking, grocery shopping, pharmacy shopping, and general merchandise purchasing to provide advice and alternative recommendations during any purchase activity. Recommendations and advise can include on-line visual display components. For example, a user avatar display can be configured to reflect health and wellness activity of the user. The user avatar can be configured to display a current health and wellness state for the user. The avatar can be modified over time to reflect changes in the health and wellness state for the user, based on the user's goal performance. Further, the visual display component can be shared over various social networks to promote improvement in health and wellness both individually and among social groups.

### BACKGROUND

1. Field of the Invention

The present disclosure is directed to health and wellness monitoring systems, and more specifically to communicating recommendations and monitored performance relating a user's health and wellness activity.

2. Related Art

Health and wellness is a rapidly evolving area of interest to all consumers. In particular, the social shopping domain is expanding to provide dietary assistance and guidance in a number of areas. Typically, dietary guidance and assistance is provided by companies looking to sell their services and/or brand. The guidance and assistance is thus limited to the scope of the domain in which the company operates.

### SUMMARY

In broad overview, various aspects are directed to providing health and wellness guidance and support both in social settings and through other on-line platforms. The on-line platforms can integrate health and wellness goal definition, activity tracking, grocery shopping, pharmacy shopping, and general merchandise purchasing to provide advice and alternative recommendations during any purchase activity. Recommendations and advice can include an on-line visual display component. For example, a user avatar display (e.g., a computer display of a human form or approximation) can be configured to reflect health and wellness activity of the user. The user avatar can be configured to display a health and wellness state for the user's purchase activity. The avatar can be modified over time to reflect changes in the health and wellness state for the user. Further, the visual display component can be shared over various social networks to promote improvement in health and wellness both individually and among social groups.

According to one aspect of the present invention, a system for delivering health and wellness recommendations is provided. The system comprises at least one processor operatively connected to a memory, the processor configured to execute a plurality of system component is provided. The plurality of system components comprises a goal component configured to establish health related goals for a user, a monitor component configured to monitor shopping activity for the user, a recommendation component configured to generate recommendations for purchase items based, at least in part, on analysis of the shopping activity and the health related goals, and a communication component configured communicate the recommendations to the user, wherein at least some of the recommendations are communicated during at least some on-line shopping activity.

According to one embodiment of the present invention, the plurality of system components further comprises a visualization component configured to define an avatar for the user. According to another embodiment of the invention, the visualization component is further configured to modify the avatar based, at least in part, on monitored activity associated with the health related goals. According to another embodiment of the invention, the visualization component is further configured to publish the avatar. According to another embodiment of the invention, the plurality of system components further comprises a user interface component configured to accept information on at least one user, including account information for on-line shopping accounts.

According to one embodiment of the present invention, the on-line shopping accounts include at least one of an on-line grocery system, an on-line pharmacy system, and an on-line general merchandise system. According to another embodiment of the invention, the plurality of system components further comprises an analysis component configured to analyze the monitored activity to determine health and wellness performance. According to another embodiment of the invention, the analysis component is further configured to generate statistical models for expected purchase characteristics. According to another embodiment of the invention, the analysis component is further configured to determine health and wellness performance based on comparing user purchases to a statistical model for expected purchases. According to another embodiment of the invention, the recommendation component is further configured to generate at least one alternative purchase selection based on the analyzed nutrition characteristics. According to another embodiment of the invention, the recommendation component is further configured to generate at least one alternative purchase selection based on a user profile. According to another embodiment of the invention, the recommendation component is further configured to notify a user of food and drug interactions.

According to aspect of the present invention, a computer implemented method for delivering health and wellness recommendations is provided. The method comprises establishing, by a computer system, health related goals for a user, monitoring, by the computer system, shopping activity for the user, generating, by the computer system, recommendations for purchase items based, at least in part, on analysis of the shopping activity and the health related goals, and a communicating, by the computer system, the recommendations to the user, wherein at least some of the recommendations are communicated during at least some on-line shopping activity of the user. According to one embodiment of the present invention, the method further comprises an act of establishing an avatar for the user for display on a user interface. According to another embodiment of the invention, the method further comprises an act of modifying the avatar based, at least in part, on monitored activity associated with the health related goals. According to another embodiment of the invention, the method further comprises an act of publishing the avatar. According to another embodiment of the invention, the method further comprises an act of accepting information on at least one user, including account information for on-line shopping accounts.

According to one embodiment of the present invention, the on-line shopping accounts include at least one of an on-line grocery system, an on-line pharmacy system, and an on-line general merchandise system. According to another embodiment of the invention, the method further comprises an act of analyzing the monitored activity to determine health and wellness performance. According to another embodiment of the invention, the method further comprises an act of generating statistical models for expected purchase characteristics of the user. According to another embodiment of the invention, the method further an act of determining health and wellness performance based on comparing user purchases to a statistical model for expected purchases. According to another embodiment of the invention, the method further comprises an act of generating at least one alternative purchase selection based on analyzed nutrition characteristics of the purchases. According to another embodiment of the invention, the method further comprises an act of generating at least one alternative purchase selection based on a user profile. According to another embodiment of the invention, the method further comprises an act of notifying a user of food and drug interactions.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a block diagram of an example system architecture for an embodiment of a health and wellness platform, according to aspects of the invention;

FIG. 1B is a block diagram of an example system architecture for an embodiment of a health and wellness platform, according to aspects of the invention;

FIG. 1C is a block diagram of an example system architecture for an embodiment of a health and wellness platform, according to aspects of the invention;

FIG. 1D is a block diagram of an example system architecture for an embodiment of a health and wellness platform, according to aspects of the invention;

FIG. 2 illustrates an example process for delivering recommendations to a user based on established goals, according to aspects of the invention;

FIG. 3 is an example process for providing health and wellness recommendations during on-line shopping activity, according to aspects of the invention;

FIG. 4A is an example process for defining a user avatar, according to aspects of the invention;

FIG. 4B is an example display of a current state avatar, according to aspects of the invention;

FIG. 4C is an example display of a goal avatar, according to aspects of the invention;

FIG. 5 illustrates an example process for reporting on health and wellness performance using a visual display, according to aspects of the invention;

FIG. 6 illustrates an example process for determining user performance, according to aspects of the invention;

FIG. 7 illustrates an example process for defining user goals, according to aspects of the invention;

FIG. 8 illustrates an example process for generating health and wellness recommendations, according to aspects of the invention;

FIG. 9 is a block diagram of an example architecture for a general purpose computer system on which various aspects of the invention can be implemented;

FIG. 10 is a block diagram of an example architecture for a general purpose computer system on which various aspects of the invention can be implemented; and

FIG. 11 illustrates an example process for capturing registration information, according to aspects of the invention.

### DETAILED DESCRIPTION OF THE INVENTION

According to some aspects, a health and wellness platform can enable a user to define and track health and wellness goals. The platform can be configured to monitor the user's on-line activity to determine compliance with the user defined goals. In particular, some embodiments of the health and wellness platform can be integrated with the user's grocery and/or pharmacy purchasing sites. In one example, the platform can monitor grocery purchasing during a user's shopping experience to determine health and wellness scoring for grocery items as they are purchased or added to a user's on-line shopping cart. The scoring can reflect nutritional information for the grocery items. The health and wellness scoring can also be determined relative to the user defined goals. Further, analysis of the purchases made or considered enables the platform to automatically deliver recommendations for healthier alternatives and/or alternatives that better meet the user's goals. Any recommendations can be communicated to the user during their shopping experiences.

In some embodiments, analysis of the purchases can include warnings specifically tailored to user profile information. User profile information can be obtained from integrated systems and/or can be developed from tracked purchase activity. In one example, a pharmacy system can maintain a user profile on the user accessing the health and wellness platform. The user profile can include, for example, the user's current medical conditions. Various grocery purchases can trigger warnings specific to the user's current medical conditions. For example, a user with high blood pressure can receive warnings regarding grocery purchases with high sodium content. Certain prescriptions can include food interaction information, and the health and wellness platform can communicate warnings advising of potential interactions. Potential interactions and recommendations to resolve them can be displayed to the user during a purchase experience.

In another embodiment, prescription fills can be monitored by the health and wellness platform. Each prescription can be associated by the platform with conditions the medication treats, and the platform can provide recommendations based on past pharmacy purchases. For example, monitored activity for a filled prescription treating high blood pressure can cause the health and wellness platform to recommend low salt content grocery items during a grocery shopping experience. In another example, fibromyalgia medication purchases can be monitored and identified. During grocery shopping activity, the platform can recommend alternatives having no or reduced amounts of gluten for any grocery item(s) placed in a shopping cart.

In another aspect, health and wellness tracking by the platform can include a user modifiable visual display component. In one embodiment, the user is able to define a health and wellness avatar display associated with the user and their current health and wellness state. In one example, the avatar includes a human form display, which can be tailored according to the user's preference. Characteristics including: male, female, height, weight, age, etc. can be incorporated into the computer displayed avatar. The user can also define a “goal” avatar associated with the user's health and wellness goals. The health and wellness platform can transition the current avatar associated with the user's current health and wellness state to display the goal avatar based on tracking and monitoring of the user's grocery, pharmacy, and/or general merchandise purchasing activity.

User defined goals can be accomplished over time, and the platform can change the current avatar incrementally to reflect a degree or percentage of achievement of a user defined goal. In addition, the accomplishment of a goal or a portion of a goal can be shared over social networks. In one example, the user or the system can publish the user's avatar to social groups identified by the user. The changes in the avatar provide visual indicators to the group regarding health and wellness accomplishments. Sharing health and wellness activity can reinforce positive behavior and assist the user and the group in achieving their goals. In some embodiments, the health and wellness platform can automatically establish a current avatar based on information about the user, (e.g., height, weight, age, fitness level, etc.), and automatically define a goal avatar display based on user input goals.

Example System

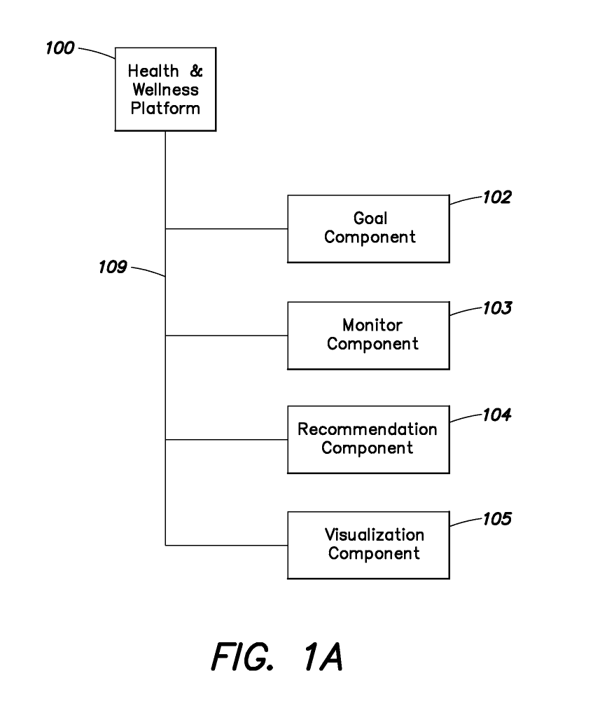

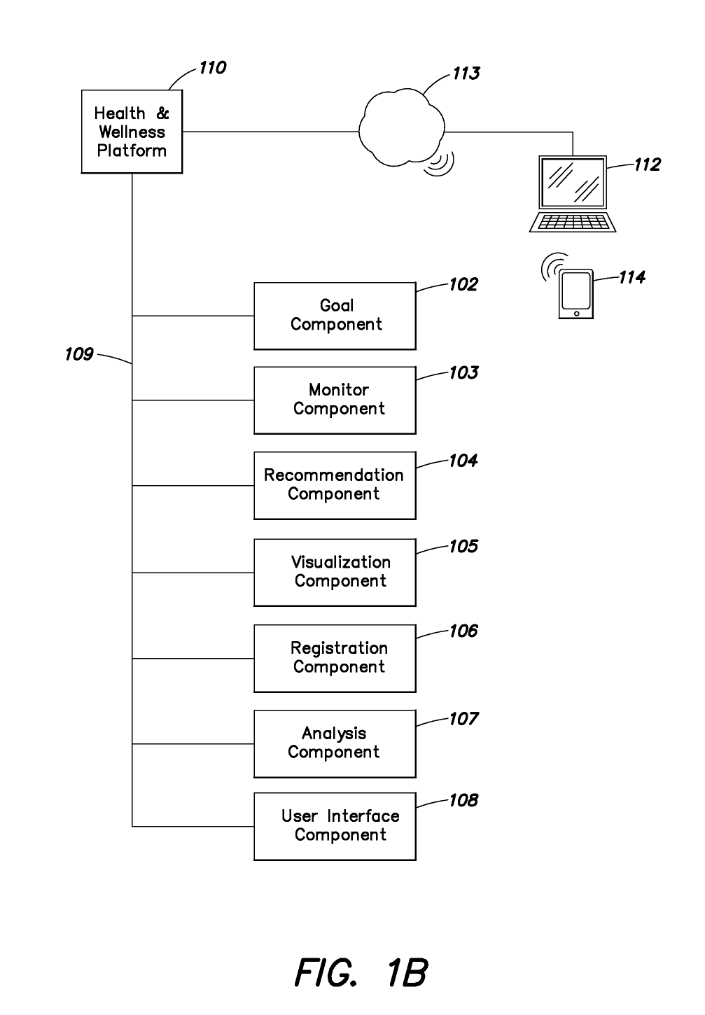

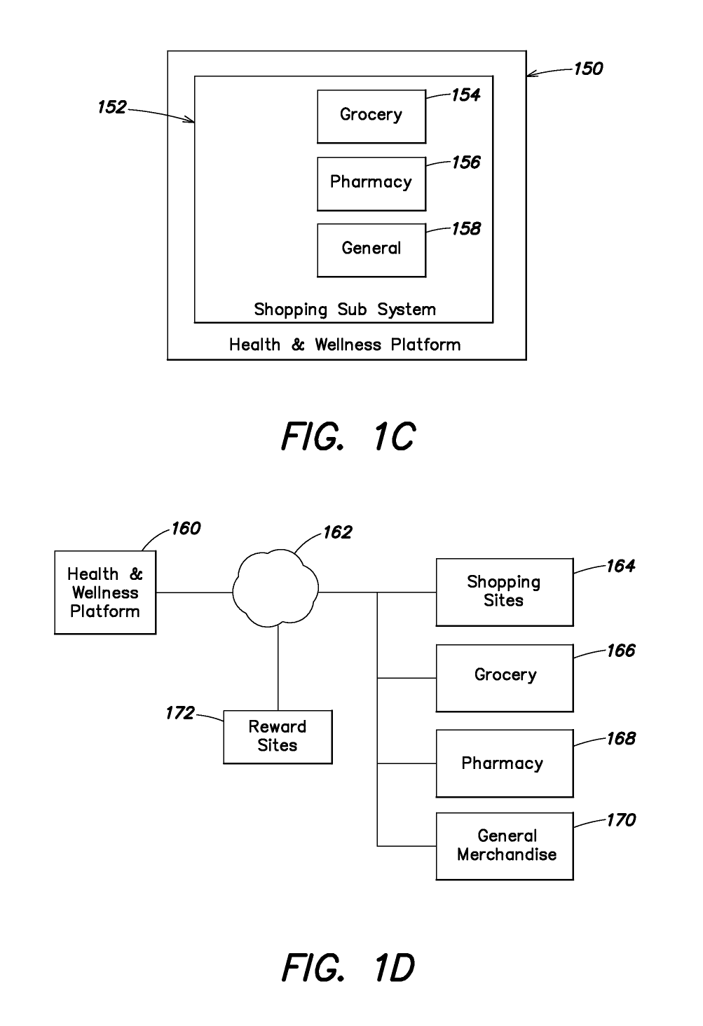

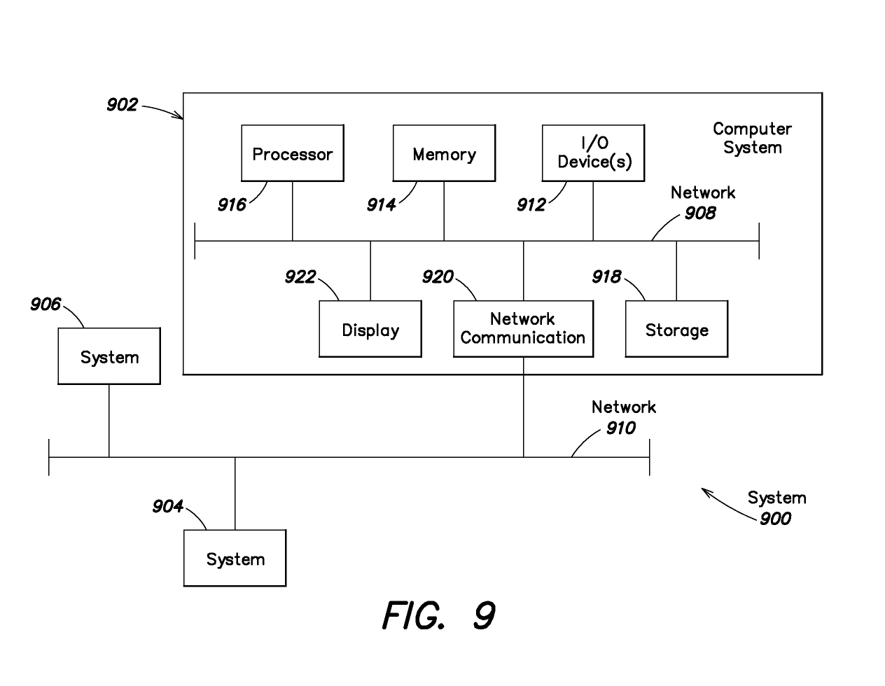

Shown in FIG. 1A is a block diagram of an example system architecture for an embodiment of a health and wellness platform 100. Health and wellness platform 100 can include a plurality of executable system components that when executed enable system functions and operations described herein. For example, health and wellness platform 100 can be a general purpose computer system, (e.g., FIG. 9, system 900), specially configured to perform the processes and/or functions discussed.

In one embodiment, the health and wellness platform 100 includes a goal component 102. The goal component is configured to define health related goals on the platform for users. Goals can be defined for individual users, groups defined by the users, groups of users, etc. In one example, a registered user can identify individual goals and also define family based goals. Compliance with defined goals can be monitored in a variety of settings by a monitor component 103. The monitor component 103 can be configured to track user purchase activity, for example, in grocery, pharmacy, or general merchandise setting(s). The tracked activity can be evaluated against the defined goals and/or other health and wellness criteria.

The tracked activity can be evaluated to provide visual feedback on goal performance. For example, a visualization component 105 can be configured to establish and modify a visual display based on goal performance. In some embodiments, visualization component 105 is configured to generate an avatar resembling a human form. The visualization component 105 can be configured to modify the avatar based on goal performance. In some embodiments, the avatar display is modified to reflect improvements in health, (e.g., the avatar is displayed with a smaller waist, better form, improved tone, better definition, etc.), as goals or portions of goals are achieved.

The platform 100 can also be configured to generate recommendations based on the monitored purchase activity. The recommendations can be provided in real time by a recommendation component 104 of the health and wellness platform. The recommendation component 104 can be configured to communicate healthier alternatives to purchase items, as the purchase items are selected. For example, on-line grocery orders can be monitored and different grocery purchases recommended in response to the user viewing or adding a grocery item to a purchase cart. In another example, recommendations can be tailored to specific health information on the user. In some embodiments, recommendations can also be tailored to the user defined goals.

Recommendations can reflect improvements in purchase items selected by the user, but can also be determined based on a shortfall identified by the platform. In some embodiments, goals can be established on the platform using a goal component, that defines nutritional requirements. Shortfalls in the nutritional requirements can be resolved by recommendations for dietary supplements, for example. A variety of goals can be established on the health and wellness platform, for example, by a goal component.

Goal Component

As discussed, the goal component 102 can be configured to define health related goals in response to user input received by the health and wellness platform. The goal component can also be configured to provide a plurality of predefined health related goals. In some embodiments, the platform can display the plurality of predefined goals for selection in a user interface. For example, weight loss can be selected as a goal for a user. Other goals can include: reduce calorie intake, reduce calories per serving, lower sodium intake, reduce sugar consumption, reduce fat consumption, increase physical activity, increase exercise, lower carbohydrate intake, manage medical condition, etc. The goal component can also permit selection of, for example, ideal weight, eating proportions of a nutrition category, (e.g., protein, fat, carbohydrates, sugar, salt, etc.).

In some embodiments, the goal component 102 can be responsive to selections made by a user in a user interface displayed on a host computer system. The goal component 102 can be configured to communicate goal options and settings for display in the user interface. The goal component can also be connected to a system memory to store the selected goals. In some embodiments, the goal component can accept goal definition entered directly by the user into the user interface. For example, the goal component can be configured to accept “lose 10 pounds” as a user entered goal. The goal component can also be configured to accept more generic goals including “lose weight,” for example. In one embodiment, the goal component can select one or more predefined goals to associate with any user entered goals. “Lose weight” can be associated by the goal component with one or more of: reduce calories per serving, reduce fat per serving, reduce total calories consumed, etc.

In some embodiments, the goal component can initiate an interactive session with the user to identify and select goals with measureable characteristics. Measureable characteristics can include target amounts/levels of nutritional characteristics for food items among other examples. In particular, the goal component is configured to establish characteristics that can be measured by tracking purchase activity by a monitor component 103, (e.g., nutritional category proportion, calories per serving, fat content, etc.).

The goal component can also be configured to establish time frames for each goal. In one example, goals can be defined as a weekly goal, monthly goal, or against another period of time, including achievement of the goal by a date. Based on the goals selected by the user or defined by the goal component 102, user activity can be monitored by a monitor component 103 to determine goal performance.

Monitor Component

The monitor component 103 is configured to track purchase activity for a user registered with the health and wellness platform. In some embodiments, monitor component 103 access other purchase subsystems to obtain purchase activity data. For example, monitor component 103 can be configured to execute integration functions and/or operations to enable the monitor component to capture on-line purchase activity of a user. In some embodiments, the monitor component 103 is specially configured to monitor and analyze on-line shopping activity. For example, the monitor component can request that the user provide registration information for any on-line grocery services the user has active. In addition, the monitor component 103 can request information on other purchase accounts, reward membership accounts, including for example, accounts with pharmacy ordering systems, grocery ordering systems, and/or general merchandise ordering systems. The requested information can be used by the monitor component to access the subscribed systems to obtain purchase information for tracking and analysis. In another embodiment, the monitor component 103 can be configured to capture grocery purchases as they are being entered by the user based on the registration information provided by the user.

In some settings, the health and wellness platform and/or the monitor component 103 can include locally executable components that can monitor on-line shopping activity as it takes place on a user's computer system. In one embodiment, the monitor component 103 can include the locally installable and executable component(s) that may be downloaded by the user and run on a local computer system. In another embodiment, the monitor component can be configured to download and install the locally executable component on a host computer system of a user. In one example, the locally executable components can be provided for download as an “App” obtained from a known “App Store.” According to some embodiments, the health and wellness platform does not need to integrate with other shopping platforms or require registration information, rather the locally executable component(s) can be configured to capture data from shopping activity being performed on a host computer system at a user location.

In some embodiments, the health and wellness platform can be configured to access an on-line purchase site once the user logs into the health and wellness platform. For example, the monitor component 103 can be configured with a browser process, so that a user can access a website for an on-line shopping venue while logged into the health and wellness platform. In some additional embodiments, a integrated health and wellness platform can be connected to on-line grocery providers, on-line pharmacy providers, and on-line general merchandise providers. In some embodiments, integration of the on-line providers can include universal account access information, which can eliminate the need for separate registration information on the user's purchase accounts.

The monitor component 103 can be further configured to capture purchase data as it is entered and/or acknowledged by an on-line shopping venue. In one embodiment, the monitor component 103 can capture the purchase data in real or near real time as part of a browser process executed for a user logged into the health and wellness platform. In another embodiment, the monitor component can be configured to poll data from a shopping site. In yet another embodiment, the monitor component can be configured to log into a shopping site concurrently with a user to capture purchase information.

In some examples, the monitor component is also configured to track off-line purchase activity. The monitor component 103 can be configured to access reward accounts or membership accounts that provide information on historic purchases. The monitor component can capture the historic purchase information, (off-line and on-line purchases), from the on-line reward accounts. In some other embodiments, a user can input purchase information for monitoring and/or analysis. In one example, a user can scan or take a picture of a purchase receipt. The monitor component 103 can retrieve associated information for the purchases on the receipt and include the associated purchase information as part of the user's monitored activity. In another embodiment, the user can take a picture of a bar code, for example, on a smart phone for an item to enable monitoring of the purchase activity.

In some settings, a purchase location or store can be equipped with networked scanner devices. The scanner devices can be configured to record purchases based on scanned bar-codes. The networked scanner devices can be configured to deliver the recorded purchases to a reward account managed by the purchase location. In some environments, the health and wellness platform can receive purchase information directly from the networked scanner devices.

In one embodiment, analysis of a purchase can include capturing nutrition information on a purchased consumable item, for example, a food item. Nutrition information on food items can be stored and accessed from a system memory. For example, a health and wellness platform can be operatively connected to a database containing nutrition information for a variety of consumable items (e.g., food, vitamins, supplements, etc.). The consumable items can include grocery items, pharmacy items, etc. In other embodiments, the health and wellness platform can obtain and store nutrition information obtained from on-line resources.

The purchased food item can be rated by the monitor component 103 and the ratings displayed to the user during their shopping experience. The rating can be based on any health related goal established on the system. For example, the rating can be based on the nutrition information for the purchased food item. A food item with a high calorie per serving rating can be flagged for user review. In some embodiments, the specific nutrition information associated with the food item identified as not meeting a goal or nutritional criteria can be highlighted, when displayed with other associated nutrition information that does meet the goal or nutrition criteria. In some settings, a recommendation component 104 can be configured to recommend an alternative product having better nutritional characteristics.

Recommendation Component

The health and wellness platform 100 can include a recommendation component 104 configured to generate recommendations for delivery to a user. The recommendation component 104 can be configured to identify comparable consumable items having better health and wellness characteristics than a current selection. For example, as a user selects a consumable item for purchase, the monitor component 103 can identify the purchase item and communicate identifying information for the item to the recommendation component 104. The recommendation component can be configured to analyze comparable items to identify a recommended purchase with better health and wellness characteristics or that meets any user defined goals established on the health and wellness platform.

For example, the recommendation component 104 can receive information on a food item added to a shopping cart from the monitor component 103. In one embodiment, the recommendation component can also receive the nutritional characteristics for the item from the monitor component 103. In another embodiment, the recommendation component can be configured to access or obtain nutritional information on the food item, for example, from a connected database of consumable items and nutrition information. The recommendation component 104 can review available consumable items and associate information to identify alternate purchases having better characteristics. For example, an alternative food item can be selected by the recommendation component 104, where the alternative has fewer calories per serving, less fat content, lower fate percentage, less saturated fat, etc. In another example, the recommendation component can identify alternatives in the same category to identify healthier alternatives to the food item in the shopping cart, (e.g., replace ground beef with ground turkey, select leaner meats, etc.). In other examples, an alternative food item may share some of the same identifying information, for example, “pizza” but have better nutritional information, for example: fewer calories per serving, smaller percentage of fat per serving, fewer total calories, etc. In some embodiments, recommendations can be communicated to a user during the user's shopping experience in real time or near real time.

In another embodiment, recommendations are generated by the recommendation component 104 to improve, for example, nutritional characteristics in accordance with user defined goals. Comparable items can be identified based on classification, and the set of comparable items analyzed to identify the item or items associated with improvements in goal based characteristics. In one example, the recommended items can be communicated to the user in a user interface as the user adds items to an on-line purchase cart. In another embodiment, recommendations can be delivered to other electronic devices, for example, a smart phone during shopping activity.

In some embodiments, the user can be presented with a selectable icon in a user interface display to initiate recommendations by the health and wellness system. In one example, a “review my cart” button is displayed within a user interface, and the health and wellness system or recommendation component 104 can be configured to deliver recommendations responsive to selection of the button in the user interface.

In some examples, recommendations can be based on analysis of an entire shopping cart. Further, the recommendations can be selected by the recommendation component 104 based on improvements in nutritional characteristics and/or goal defined characteristics. In some embodiments, the recommendation component 104 can be a sub-component of the monitor component and in others, the monitor component 103 can be configured to perform any or all of the functions discussed with respect to the recommendation component.

Visualization Component

Communicated recommendations can be accompanied by visual indicators of nutritional and/or goal based characteristics as well as adverse indications for medical conditions. In one embodiment, health and wellness platform 100 includes a visualization component 105. The visualization component 105 can be configured to generate and communicate graphical displays of, for example, nutrition information for monitored purchase selections. In some embodiments, the graphical displays can be configured to highlight nutrition information that exceeds, meets, or does not meet user defined goals. In some embodiments, highlighting of visual displays can be also be employed if the nutritional information exceeds default thresholds. The default thresholds can be established on the health and wellness system, for example, based on the known government recommended daily allowance (“RDA”) statistics.

In some examples, the visualization component 105 can generate status bar displays associated with nutritional information for a purchase. Each applicable nutritional category (e.g., calories, fat calories, fat %, carbohydrates, carbohydrates %, carbohydrates calories, calcium, iron, magnesium, chromium, phosphorus, chloride, potassium, sodium, fluoride, iodine, zinc, copper, manganese, selenium, vitamins and minerals, vitamin A, vitamin E, vitamin D, vitamin C, vitamin B1 (thiamin), vitamin B2 (riboflavin), vitamin B3 (niacin), vitamin B5 (pantothenic acid), vitamin B6, biotin (vitamin B7), Folic Acid (vitamin B9), vitamin B12, vitamin B13, vitamin B15, vitamin B17, vitamin K, folic acid, tryptophan, threonine, isoleucine, leucine, lysine, methionine, cysteine, phenylalanine, tyrosine, valine, arginine, histidine, alanine, aspartic acid, glutamic acid, glycine, proline, serine, cholesterol, essential fatty acids, trans fat, saturated fat, and any other categories listed on the RDA) can be displayed with a status bar reflecting the percentage of a daily allowance or a goal amount for each category. Each status bar can also be color coded to reflect categories that meet goal criteria or daily allowance criteria. Green status bars can indicate categories for which goals are met, yellow status bars can reflect categories that can be improved, and red status bars can reflect categories for which an alternative selection should be made.

In some embodiments, each category and associated status bar can be aggregated across a group of purchases. For example, each category can be evaluated against all the items in an entire shopping cart and/or multiple shopping carts. In some embodiments, the visualization component can generate other displays including, for example, pie charts and/or bar graphs which illustrate how close the purchase item(s) and/or cart are to any goal and/or nutritional characteristics.

The visualization component 105 can also be configured to generate dynamic displays based on goal performance over time. In some embodiments, the visualization component can enable a user to select or generate an avatar associated with a current health and wellness state for that user. The visualization component can further enable selection or generation of a goal avatar having a different display appearance than the current state avatar. Upon completion of goal activities or portions of an identified goal, the current state avatar can be modified to display with characteristics of the goal avatar. The modifications can be made incrementally upon completion of a portion of the goal, over time, etc., until the goal is met and the current state avatar is the same as the goal avatar.

In some embodiment, individual purchases can be excluded from consideration for health and wellness criteria and/or goals. For example, purchases made for others can be identified in a user interface by the user to exclude from considerations. In another example, purchases can be made for other participants and the user can identify other users to have the purchased considered against the other users health and wellness criteria and/or goals.

In some settings, the visualization component 105 can be further configured to publish the avatar. For example, the visualization component can publish the avatar to social network site associated with the user. Any modifications to the current state avatar can be published at various stages of goal completion including the completion of a user defined goal.

In one embodiment, a user can select or create an avatar associated with their current health and wellness state. The current health and wellness state can include user profile information (e.g., height, weight, body fat %, BMI, age, existing medical conditions, blood pressure, cholesterol counts (HDL and/or LDL)). In one example, the avatar is a human form display having physical display characteristics reflective of the users current health and wellness state. For example, a larger waist on the avatar can reflect a user having a weight greater than ideal. A corresponding goal avatar can include, for example, a narrower display waist reflective of a weight loss goal. The visualization component 105 can be configured to accept user submitted modification to any avatar display. For example, the user can customize their avatar (current or goal) to conform to the user's expectations or desires.

In some embodiments, definition of a goal avatar is unnecessary as modifications can be made to the current state avatar based on changes in a user's health and wellness state. Loss of weight can trigger a modification to the avatar's displayed waistline or other body dimensions. Increases in physical activity level can be reflected in modifications to the avatar's display posture and/or visualization of the avatar's musculature, for example. A variety of modifications to physical display characteristics can be visualized by the visualization component 105 based on, for example, goal performance. The visualization component can also be configured to modify display characteristics based on health and wellness scoring of any tracked purchase, including, for example, general merchandise purchases reflecting improvements in health. Purchases of exercise equipment, for example, can be scored by the health and wellness platform as reflective of improvements in physical activity levels and/or increased levels of exercise for a given user. These improvements can be reflected in modification to the user's corresponding avatar.

Other Components

Shown in FIG. 1B is a block diagram of another example system architecture for an embodiment of a health and wellness platform 110. Health and wellness platform 110 can include a plurality of executable system components (including e.g., components 102-105 discussed above) that when executed enable system functions and operations described herein. For example, health and wellness platform 110 can be implemented using a general purpose computer system (e.g., FIG. 9, system 900) having at least one processor connected to a memory, wherein the processor when executing is specially configured to perform the processes and/or functions discussed.

In some embodiments, a health and wellness platform can also be integrated with shopping subsystems, that provide for on-line shopping in grocery, pharmacy, and general merchandise categories. Shown in FIG. 1C is a block diagram of an example system architecture for an embodiment of a health and wellness platform 150. Platform 150 includes shopping subsystem 152. Platform 150 and shopping subsystem 152 can be operated by a single provider, permitting a single registration for any of the shopping sites (e.g., grocery 154, pharmacy 156, and general merchandise 158) of the shopping subsystem or the health and wellness platform 150 to create user accounts accessible by any of the other systems.

In other embodiments, the health and wellness platform can be connected to external shopping sites via a communication network 162. FIG. 1D is a block diagram of an example system architecture for an embodiment of a health and wellness platform 160. The health and wellness platform 160 can communicate with external shopping sites 164 to obtain purchase activity for a given user. Health and wellness platform can be configured to communicate with grocery delivery site(s) 166, pharmacy site(s) 168, and/or general merchandise sites 170. In some embodiments, the health and wellness platform 160 can also be configured to capture purchase information from on-line rewards accounts with other merchants permitting capture of both on-line and off-line purchase activity. For example, platform 160 can communicate with on-line reward sites 172 using account information provided by an end-user.

Returning to FIG. 1B, in some embodiments, health and wellness platform 110 can include a registration component 106 that can be configured to register users. Registration can include identification by the user of on-line shopping sites and/or accounts. In some embodiments, the registration component 106 can be configured to request account information for the on-line shopping sites including access information (e.g., user names and passwords).

Registration Component

The registration component 106 can also be configured to request information on shopping memberships, reward accounts, and/or other on-line sources of purchase activity. The information requested can include account access information, so that the health and wellness platform can capture purchase activity performed on external accounts. In some examples, credit card information (e.g., account and/or access information) can also be obtained.

Registration component 106 can be configured to capture account information for any one or more shopping sites, grocery delivery services, pharmacy fulfillment sites, general merchandise sites, and reward accounts held by a user. The user can enter account information in a user interface displayed on a host computer system 112, which can include, for example, portable computing devices, smart phones 114, or other mobile computing devices. Once the account information is captured, the information can be stored in an attached memory for use by other system components. Any registered account information can be used by the health and wellness platform to monitor purchase activity.

Analysis Component

In some embodiments, the health and wellness platform 110 can also include an analysis component 107. The analysis component can be configured to analyze monitored purchase activity obtained by, for example, monitor component 103. Analysis component 107 can be configured to operate in conjunction with monitor component 103 to determine health and wellness scoring for purchase activity. In some embodiments, analysis component 107 can be configured as a sub-component of monitor component 103.

In some embodiments, scoring of purchase activity can be determined by the analysis component based on user defined goals. In one embodiment, analysis component 107 analyzes on-line purchase activity. Each purchase item can be evaluated for nutritional characteristics and/or other health and wellness criteria to determine if defined goals are satisfied given the current purchases. For example, grocery items can be analyzed for their nutritional information. The analysis component 107 can be configured to extrapolate, for example, calories per serving, fat consumption, sugar consumption, etc., over periods of time based on analysis of the nutritional information obtained for individual purchases or aggregation of purchases. The analysis component 107 can compare how the extrapolated measures compare to any user defined goals (e.g., weight loss, reduce fat intake, etc.) and score them accordingly. For purchases that have not been completed, the analysis component can communicate the scoring and/or underlying data to a recommendation component (e.g., 104) for real-time or near real-time improvement suggestions.

The analysis component can also be configured to extrapolate purchase information to project purchase activity of a period of time comparable to periods of times set for user goals. For example, a user can establish a monthly goal to reduce calories per serving in meals. The health and wellness platform and/or the analysis component 107 can be configured to aggregate purchases over the month to determine a benchmark monthly calorie per serving figure. In another example, individual purchases and their associated nutritional information can be projected as if the item was purchased over the monthly period and then compared to the benchmark value to determine if the goal will be met, not met, or exceeded. In yet another example, known or identified purchases and associated nutritional information can be averaged and the average projected over the period of time to compare to user defined goals. The analysis component 107 can also be configured to model past purchase information into statistical models of expected purchase characteristics. Current purchases and/or shopping carts to be purchased can be evaluated against the statistical models to determine how close the user is or will be to meeting the user defined goals.

In some embodiments, the analysis component 107 can be configured to request recommendations from a recommendation component 104 when the analysis component identifies purchases that fail to meet user defined goals or other default settings. Further, the analysis component 107 can be configured to communicate the analyzed information to a visualization component (e.g., 105) which can render visual indications of the results of the analysis.

The various components (e.g., 102-107) of the health and wellness platform 110 can be connected via a interconnection mechanism 109. In one embodiment, the interconnection mechanism 109 can enable communication between the analysis component 107 and a visualization component 105. Communication can occur between processes over a bus or between separate computing systems via a network. In some embodiments, the interconnection mechanism 109 can include one or more busses that permit computer executed processes to communicate. In some examples, the interconnection mechanism can include communication networks enabling inter-component communication of data.

In some embodiments, health and wellness platform 110 includes a user interface component 108 configured to mediate interaction between the health and wellness platform and the end user. In some embodiments, each of the components, 102-107, can be configured to communicate data first to a user interface component 108, which generates a user interface display incorporating the communicated data. The user interface display can be shown on end user computer system (e.g., 112-114). In response to user input within the user interface display, user interface component 108 can accept the input information over communication network 113 and communicate the input information to the appropriate component for processing within the health and wellness system 110.

In various embodiments, the health and wellness platform can include some or all of the components discussed above. In particular, various functions and processes discussed can be executed by any number of components, whether or not each of the discussed components is separately instantiated on the health and wellness platform. In some embodiments, a health and wellness platform can be configured to execute any or any combination of the functions discussed regardless of whether the individual components are installed on the platform.

Example Health and Wellness Processes

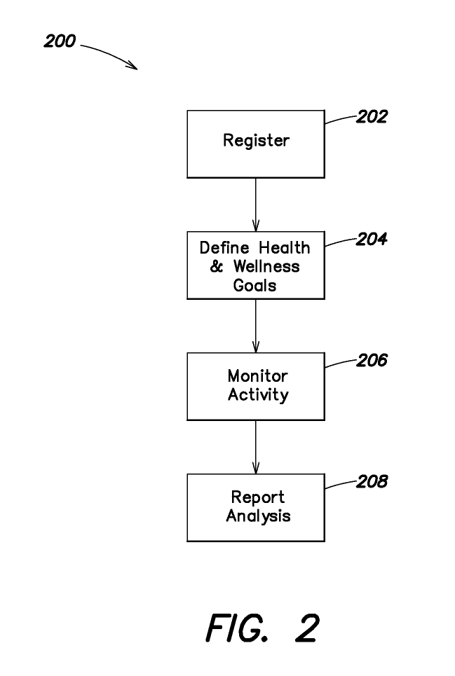

According to some embodiments, a health and wellness platform is configured to execute processes for delivering health and wellness recommendations based on defined goals. FIG. 2 illustrates an example process 200 for delivering recommendations to a user based on established goals. Process 200 can begin at 202 with an end user registering for an account. The account may be a universal account configured to provide access to a health and wellness platform, shopping sites, social network sites, etc. In some embodiments, the account is specific to a health and wellness platform. Registration at 202 can include defining account information for shopping sites that the user has registered for and/or uses to make purchases. Registration at 202 can also be configured to invoke sub-processes for capturing registration information.

Process 200 can continue once registration is complete at 204 by prompting the user to input any desired health and wellness goals. In some embodiments, health and wellness goals can be presented to the user for selection in a user interface. Health and wellness goals can be associated with a plurality of measurable characteristics. For example, a weight loss goal can be set as reduce caloric intake, or reduce calories per serving. Grocery shopping activity can be accessed for the user and monitored at 206 using the registration information provided at 202. The monitored activity can be analyzed for reporting to the user at 208. For example, the grocery shopping activity being monitored at 206 can be analyzed at 208 for nutrition information, including calories per serving. In some examples, caloric information on the purchases can be extrapolated to derive a projection of total calories based on current purchases and reported to the user at 208. In some further examples, grocery activity can be monitored in real time and when purchases exceed, meet, or do not meet goals, the user can be provided feedback at 208 during their shopping activity. Feedback at 208 can include recommendations for alternative products that meet or exceed health and wellness goals.

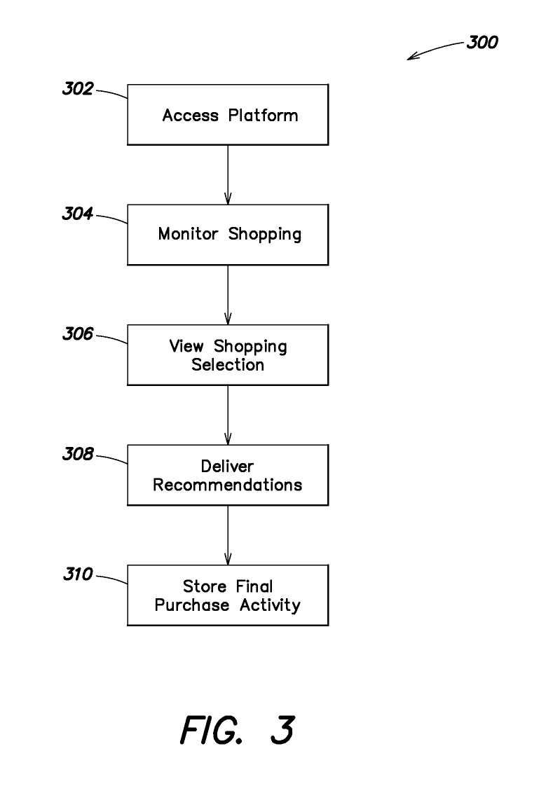

Shown in FIG. 3 is an example embodiment of a computer implemented process 300 for providing real time or near real time health and wellness recommendations during on-line shopping experiences. Process 300 can be executed by a health and wellness platform and/or system components to provide real time or near real time health and wellness recommendations during on-line shopping experiences. In one embodiment, process 300 can begin at 302, when a user accesses a health and wellness platform. The user can begin shopping at 304 within the health and wellness platform on connected shopping systems. In another embodiment, a user can begin shopping through external on-line shopping sites at 304 made accessible by the health and wellness platform via a browser executing on the computer system. The browser process can be configured to capture shopping activity as it is performed. In another example, the user accesses the health and wellness platform at 302 which is configured to track the user's shopping activity on the user's computer system upon access to the health and wellness platform. For example, accessing health and wellness platform at 302 can trigger tracking applications to be executed on a user's computer system. In other embodiments, other tracking vehicles can be executed, for example, on the user's computer system, including other processes configured to capture the user's shopping activity.

During an on-line shopping experience the user can view items or select items for inclusion in the user's shopping cart at 306. In response to the user viewing items, alternative products can be identified and recommended to the user at 308. In one example, nutritional characteristics of items in the user's on-line shopping cart can be evaluated, and matching grocery items having better nutritional characteristics can be recommended at 308. In another example, characteristics of the items in the user's on-line shopping cart can be evaluated against health and wellness goals stored on the health and wellness platform and recommendations that improve goal performance can be recommended at 308.

Recommendations can also be based on user profile information. In one embodiment, a user's medical conditions can be defined in a user profile. The medical conditions can be entered by the user or can be determined, for example, from medication purchases. Various medical conditions and/or the medications used to treat the medical conditions can cause interaction with purchased items. For example, user's having high blood pressure conditions can receive recommendations on salt content of purchased food items. Pharmacy prescriptions with known interactions can be identified and communicated to the user. In some embodiments, a variety of non-prescription alternatives or supplements to prescribed medication can be identified to the user for a medical condition.

Recommendations can also include items that are not substitutes for items in a shopping cart. For example, dietary supplements can be recommended where shortfalls in nutritional categories are identified. General merchandise recommendations can also be made at 308. For example, books on healthier eating, cooking light, and/or outdoor activities can be recommended based on selections made by the user. In some embodiments, goal triggered recommendations can include recommended purchases for exercise equipment and/or other fitness based general merchandise. Recommendations delivered at 308 can also include reminders. For example, a user with recurring prescriptions can receive reminders to refill their prescriptions during on-line shopping activity.

In some embodiments, recommendations can be delivered to the user in a browser or other user interface being used to shop on-line. In other embodiments, recommendations can be delivered separately via a user's mobile device and/or smart phone.

Once the user has completed their on-line shopping activity, the final purchases can be stored at 310. Purchases and any associated information can be stored in a database or other repository at 310. In some embodiments, historic purchases can be tracked and further analysis can be performed on the completed purchases for a user. In other embodiments, historic purchase activity can be further analyzed to identify additional alternative purchases. For example, purchase alternatives can be stored and retrieved during a subsequent on-line shopping session to improve the speed of delivery of recommendations at 308.

Further analysis can also include goal performance evaluations. In one embodiment, additional feedback can be provided to the user outside of shopping activities based on evaluations of completed purchases against defined goals. In some embodiments, visual displays can be provided to the user indicating health and wellness goal performance. In one example, avatar displays can be published to a user's social site and/or delivered to the user's mobile device. The appearance of the avatar can be configured to reflect the user's performance with respect to their health and wellness goals.

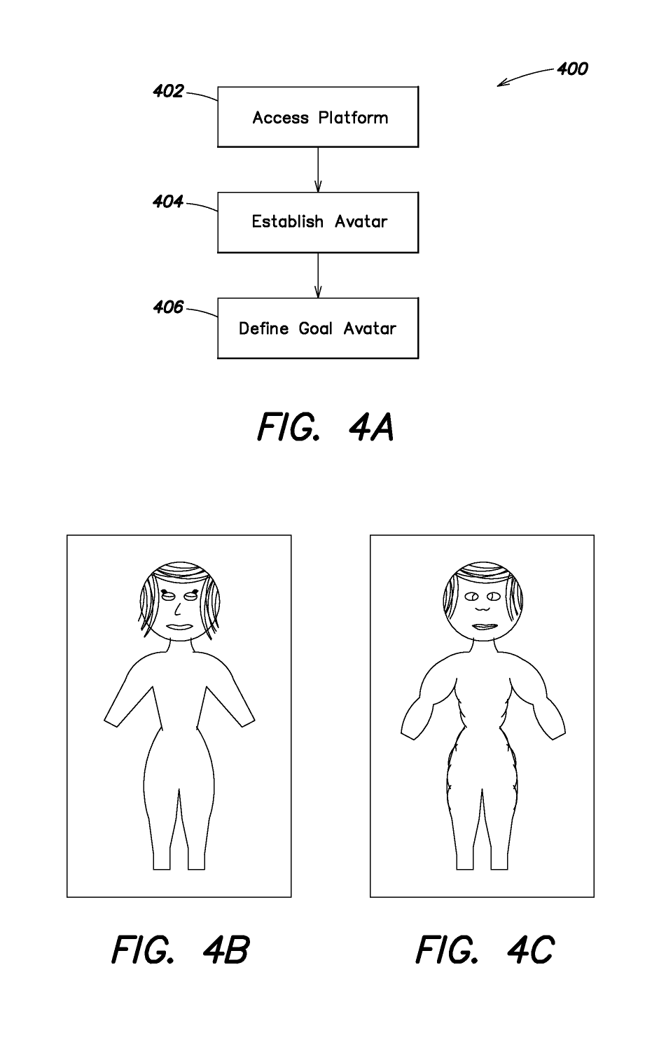

Shown in FIG. 4A is an example process 400, for defining a user avatar. Process 400 can be executed by a health and wellness platform and/or system components to enable a user to define current state avatar and/or goal avatar used by the platform or component(s). In one embodiment, process 400 can begin at 402 when a registered user accesses a health and wellness platform. The user can interact with a user interface on a host computer system. The user can access a variety of management features for their account in the user interface. In one example, the user is able to define an avatar that the user wishes to reflect their current health and wellness state at 404. The user can build, for example, a human form display in the user interface. For example, the user can define the avatar's hair color, hair position, hair style, body shape, weight, arm length, leg length, sex, age and/or other physical traits and characteristics to establish their human form avatar. Shown in FIG. 4B is an example of an avatar defined for a user.

In some embodiments, a current state avatar can be established automatically at 404. For example, user profile information can include height, weight, sex, and other characteristics that can be used to define a current state avatar for the user. The current state avatar can be a human form display shown in the user interface. The scale and sizing of the human form display can reflect body proportions based on height, weight, sex, etc.

In some embodiments, the user can review the automatically established avatar in the user interface. The user can make any modifications to the avatar as desired, including increasing and/or decreasing body mass (e.g., shrinking or enlarging the avatar's displayed waist) or other physical features (e.g., increasing/decreasing display height, etc.). For example, the user can change placement of eyes within a face, size of the eyes, display position of the nose, size of the nose, shape of the nose, display position of eyebrows, size and shape of eyebrows, etc.

Once the user defines their current health and wellness state avatar at 404, the user can be prompted to generate a goal avatar at 406. In one embodiment, the user can begin defining their goal avatar using the current state avatar as a template. The user can make any modifications desired to generate the goal avatar. In some embodiments, changes to the goal avatar reflect improvements in physical fitness (e.g., avatar is displayed with better posture), physical characteristics (e.g., reduced waistline, more defined musculature, etc.). In some embodiments, definition of the goal avatar can include defining activities that the goal avatar can perform. In some examples, the goal avatar can be shown in various action poses (e.g., running, jumping, skiing, etc.) that can reflect increases in physical activity. In other embodiments, a goal avatar can include animations that reflect the avatar performing the identified activity. An example goal avatar is illustrated in FIG. 4C.

In some embodiments, a user can define current state avatars and goal avatars on a health and wellness platform. The health and wellness platform can be configured to report progress on goals using the current state avatar and the goal avatar. For example, as goals or portions of goals are completed the health and wellness platform can modify the current state avatar to take on characteristics of the goal avatar, until a defined goal is completed and the current state avatar appears identical to the goal avatar. In one embodiment, the changes in the current state avatar can be communicated directly to the user and/or published via social networking sites.

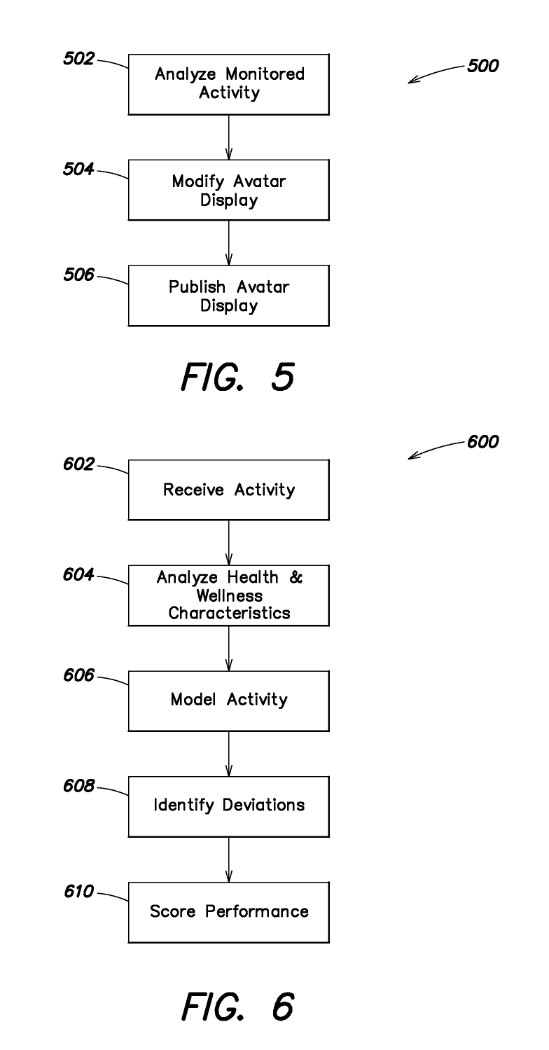

Shown in FIG. 5 is an example process 500 for reporting on health and wellness performance using a visual display. Process 500 can be executed by a health and wellness platform and/or system components to report on health and wellness performance using a visual display. Process 500 begins at 502 where user activity, and in one example shopping activity, is analyzed to determine how well the user is meeting their defined goals. Based on the analysis of the shopping activity, a current state avatar can be modified to reflect the determined performance of the user at 506. For example, a defined goal can include reduce caloric intake by a defined amount over a period of time. The analysis of the user's shopping activity can reflect partial accomplishment of the defined goal. For example, the user can obtain a measure of caloric intake reduced by an amount smaller than the goal. The positive progress toward goal completion can be represented by incremental improvements in a current state avatar. In some embodiments, a current state avatar can be modified at 504 to reflect any incremental achievement of a goal. In other embodiments, modification of the current state avatar can be limited to improvements only.

In one embodiment, the user's performance can be projected over time for time based goals, and analysis of monitored activity can be performed against projections covering the entire period. In another embodiment, the goal period can be broken into smaller intervals of time to permit analysis of the user's performance for the smaller intervals of time.

Analysis of the user's performance can result in modification of the user's avatar at 504. Current state avatars can be published for viewing by the user at 506, which may or may not reflect any modification made at 504 based on the analysis of the user's performance at 502. In some embodiments, publication at 506 can include posting to social networking sites, for example, as identified by the user. Analysis of the user's activity for goal performance and corresponding modifications of a user's current state avatar may depend on a number of factors. Such factors can include, for example, a degree of completion of a goal, projection of completion of the goal within the defined time, progress towards completion, satisfaction of goal requirements for a smaller interval of time, etc.

Shown in FIG. 6 is an example process 600 for determining user performance. Process 600 can be executed by a health and wellness platform and/or system components to determine user performance of established goals. Process 600 begins at 602 with receiving user health and wellness activity for a user. In some examples, the health and wellness activity includes purchases made by the users on shopping sites. The shopping sites can include grocery, pharmacy, and general merchandise shopping. Health and wellness activity can be received, for example, from records stored in a database, communicated from shopping sites, input by the user, captured from external sites, etc. The purchased items can be analyzed individually and/or in groups for their health and wellness characteristics.

For grocery items, nutritional characteristics can be obtained for each item. The nutritional information can be analyzed individually or as a group at 604. In some embodiments, analysis of nutritional information can require statistical modeling of the purchases and/or nutritional information at 606. For example, purchases and/or associated health and wellness characteristics can be modeled over periods of time. The modeled periods of time can be adjusted to align with time periods set for any defined goals. Individual grocery purchases are typically not consumed in their entirety at one time, thus nutritional information associated with each item and/or groups of items can be modeled to represent their nutritional information over a defined period of time.

Analysis of historical purchases can be employed to establish baseline statistical models of purchases and health and wellness characteristics and time periods. Historical trends in purchases can be modeled to more accurately project current purchases against goal and/or other health criteria. Statistical distributions can be determined, and probabilistic models fit to the historical data to allow projections of current purchases.

In some embodiments, defined goals can be modeled across the period of time established for the goal. Modeling goals over the period of time can enable direct comparison of goal attributes to health and wellness activity undertaken by a given user.

Statistical deviations can be calculated against actual, modeled, and/or projected purchases and any goal criteria defined for the user at 608. If the user has met their goals precisely no deviation is identified at 608 and the deviation or its lack can be scored at 610. In some embodiments, scoring can be straightforward with respect to a goal: met and not met. Each condition can be assigned a value, in some examples, and the value used in reporting performance. In one alternative, the conditions themselves can be used and interpreted by other processes in reporting performance. In some other embodiments, the degree of deviation can be evaluated and used to score performance at 610. Degree scores and/or categories can be assigned based on the degree of deviation: met goal, exceeds goal, far exceeds goal, etc.

For some goals, the criteria and its evaluation can be as simple as met and not met with no need for further analysis. In one example, a goal can be set by a user for managing an existing health condition. Purchasing the appropriate medications for the condition can be the measure evaluated for determining compliance/performance associated with the goal. In some embodiments, recommendations in the form of reminders to purchase the appropriate medications can be delivered to user to assist in meeting the user's goal. Scoring for such a goal may not require execution of process 600.

In some embodiments, recommendations can be determined and delivered by a health and wellness system related to the goal of managing the user's condition. For example, healthier foods selections may improve the user's ability to manage their condition. For a user with high cholesterol, on a cholesterol reducing drug, the health and wellness platform can generate recommendations for foods with low fat content, low or no cholesterol content, etc. By adopting the recommendations the user can be rewarded with improvements of their current state avatar. In some embodiments, the adoption of the recommendations can be assigned a score, and the score used in conjunction with deviation scoring to provide an overall performance score at 610.

Although, in some embodiments, multiple goals can be set for a user. In one embodiment, performance for each goal can be measured separately. In other embodiments, performance can be measured collectively. The scoring of performance can be communicated to the user via modifications of the user's display avatar (e.g., as discussed with respect to process 500). In some alternatives, the scoring of the user's performance can also be communicated directly to the user.

Various embodiments of a health and wellness platform can be configured to execute any one or more of the discussed process flows. Further, various components of the health and wellness platform can be configured to execute any one or more of the steps discussed with respect to the process flows. The process flows are intended to be exemplary and non-limiting. In some embodiments, various steps discussed can be omitted, combined with other steps, and/or executed in different order. In further embodiments, the steps of the process flows discussed can also be configured to call and/or execute other processes.

For example, process 200 can be configured to execute process 1100, for example, as part of or in conjunction with 202. Shown in FIG. 11 is an example process 1100 for capturing registration information. Process 1100 begins by requesting identifying information for the user at 1102. For example, name and address can be requested. A desired user name and password can also be requested at 1102. At 1104, the user is asked if they are participating as an individual or if they wish to participate as a family or group. If the user is participating as an individual 1104 YES, the user is asked to input their health information (e.g., height, weight, fitness level, current medical conditions) at 1106. Although the user can provide no information at 1106 and process 1100 can continue to 1108, where the user is asked for information on any shopping accounts they may be registered for. If the user has registered for other shopping accounts, 1108 YES, the user is asked to input account information at 1110. The user can be asked to submit account access information for any shopping account they may have.

In some embodiments, process 1100 can be executed on an integrated health and wellness platform (e.g., 150, FIG. 1C), thus external account information may not be necessary. However, even in integrated health and wellness/shopping environments, some embodiments can be configured to track and monitor purchase activity for external accounts in addition to activity with the platform (e.g., 150). In addition to shopping accounts, account information for reward memberships can also be requested at 1110. For example, shopping club reward memberships can track user purchases, which can be used to monitor health and wellness activity and/or make health and wellness recommendations. Once account information (e.g., shopping accounts, reward memberships, etc.) has been entered at 1110, or not if there are no accounts to enter at 1108 NO, the user can be asked if they wish to configure the health and wellness platform for social recommendations and/or performance tracking at 1112.

If the user wishes to participate in the social aspects of health and wellness recommendations and monitoring at 1112 YES, the user is asked to input account information for existing social network sites (e.g., the well known FACEBOOK system) at 1114. In some examples, the user can be registered for a social networking site automatically at 1114. Process 1110 can conclude at 1118 if the user does not wish to configure social settings at 1112 NO. In some embodiments, process 1100 is also configured to support registration of groups and/or families for health and wellness monitoring.

At 1104 NO, a user can indicate that the user is registering a group or family for health and wellness monitoring. The user is requested to identify the number of participants in the group at 1116. Process 1100 can request identifying information for each participant in the group and further can be configured to execute steps 1106-1114 for each participant. In some embodiments, identification of other participants is sufficient and process 1100 can continue at 1106 by requesting health information on the registering user, as discussed above. In some embodiments, when a user has registered for a group or family, during subsequent purchasing activity, the user may identify which member or members of the group or family is/are the intended recipient(s) of purchased items. Also separate avatars may be used for each member and/or a representative group avatar may also be used.

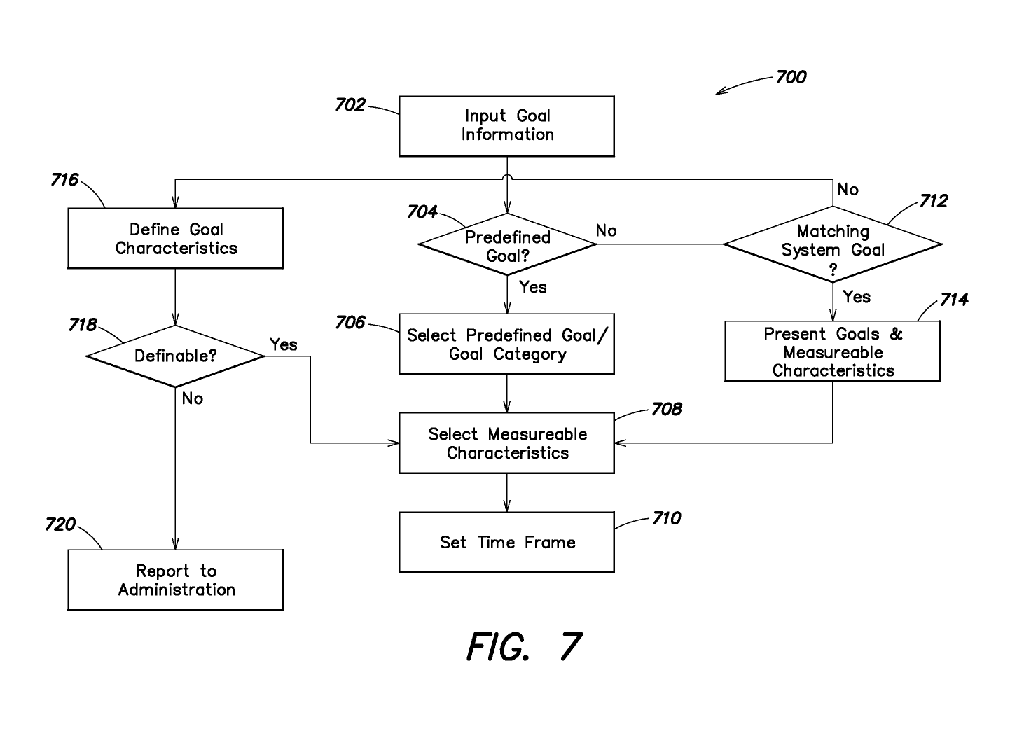

In other embodiments, processes (e.g., 200-600) can be configured to invoke other of the discussed processes. In one example, processes 200 can invoke process 700 or any portion of process 700. Shown in FIG. 7 is an example process 700 for defining user goals. Process 700 can be executed by a health and wellness platform and/or system components to define user health and wellness goals. In one embodiment, process 700 can begin at 702 with a user inputting goal information in a user interface. For example, the user can input goal information based on displays of pre-defined goals and/or goal information. In one embodiment, the information input by the user in the user interface can establish if the user wishes to choose a pre-defined health and wellness goal at 704. If the user selects a pre-defined goal 704 YES, the user can be prompted to select a specific goal or goals and/or a goal category from which to select specific goals or goals at 706.

Specific goals can include weight loss, reduce calorie intake, reduce calories per serving, lower sodium intake, reduce sugar consumption, reduce fat consumption, increase physical activity, increase exercise, lower carbohydrate intake, manage medical condition, etc. Pre-defined goals for selection can also include setting ideal weight and/or defining proportions of a nutrition category (e.g., protein, fat, carbohydrates, sugar, salt, etc.) for food items. At 708, the user can be prompted to set or select values for measureable characteristics that the user wishes to be monitored. Measureable characteristics can include target amounts/levels of nutritional characteristics for food items, among other examples. In particular, the measureable characteristics establish characteristics that can be measured by tracking purchase activity (e.g., nutritional category proportion, calories per serving, fat content, etc.).

For example, pre-defined goals can include a group of characteristics for nutritional categories (e.g., reduce fat, reduce sugar, reduce total calories, reduce calories per serving) and the user can set values for each category or select nutritional categories on which to set values. In some embodiments, historic purchasing activity is available to define current values for the user's current consumption levels of a variety of nutritional categories. Current consumption values can be displayed in conjunction with establishing goal target values at 708.

The user can also be prompted set time frames for the user's goals at 710. In some embodiments, drop down lists can be displayed in the user interface for selection by the user. For example, time frame selections can be displayed including: daily, weekly, monthly, quarterly, semi-annual, yearly, etc. In other embodiments, the user can be presented a text box for inputting a desired time frame at 710.

In some embodiments, a user may wish to enter goals not predefined on the system at 704 NO. The user can enter goal information, for example, as a text input. In some embodiments, the user entered free text defining goals can be matched to pre-defined goals at 712 YES. Matching goals and any measureable characteristics can be presented to the user at 714 in the user interface in response to determining the match at 712 YES. Text input can include “lose 10 pounds” or “lose weight” for example. “Lose weight” can be matched at 712 YES with any one or more of: reduce calories per serving, reduce fat per serving, reduce total calories consumed, etc. The goals and characteristics can be presented to the user at 714.

As discussed above, at 708, the user can be prompted to set or select values for measureable characteristics that the user wishes to be monitored. For example, pre-defined goals can include a group of characteristics for nutritional categories and the user can set values for each category or select or remove categories on which to set values. Historic consumption values can be displayed to assist the user in setting goal target values at 708. The user can then set time frames for the user's goals at 710.

If the user entered goals do not match any goals on the system 712 NO, the user is prompted to define their own goal characteristics at 716. The user can select from characteristics available on the system at 718 YES, in which case the user sets or selects values for the measureable characteristics and any time period at 710. If the user can not further define their goals or select characteristics that are available, 718 NO, the user defined goal can be stored for administrative review at 720. Review can generate recommendations to the user for trackable characteristics. In some embodiments, reviewed user defined goals can be stored for later use as predefined goals.

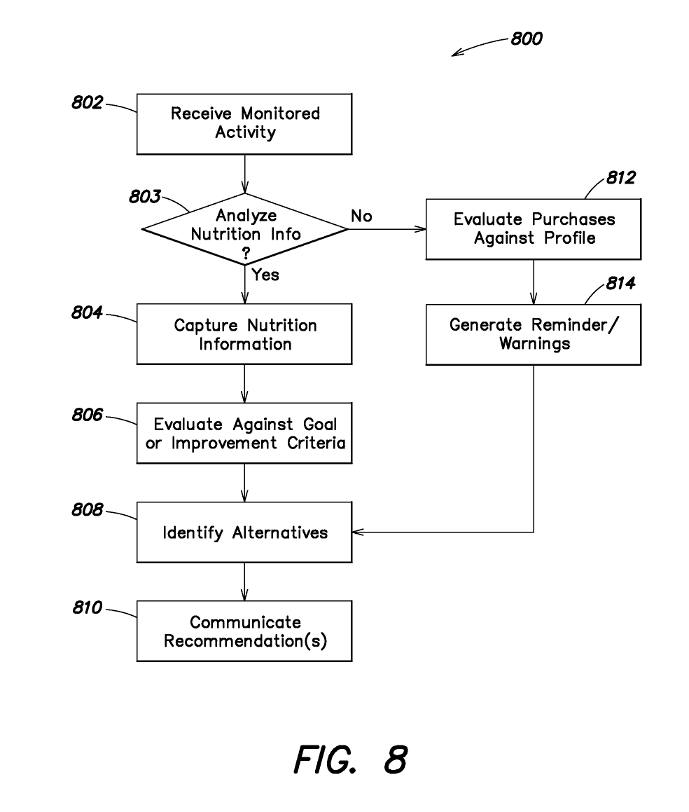

Shown in FIG. 8 is an example process 800 for generating health and wellness recommendations for a user. Process 800 can be executed by a health and wellness platform and/or system components to generate health and wellness recommendations. In some embodiments, process 800 can be invoked by other processes, for example, during execution of process 200 at step 208. Process 800 begins at 802 with receiving monitored health and wellness activity for a user. For example, on-line grocery purchases can be received from a shopping system and analyzed for nutritional properties at 803 YES. The nutritional characteristics for the purchases can be obtained either from storage or from an on-line source at 804.

The nutritional characteristics and/or other health and wellness criteria can be evaluated at 806 to determine if, for example, defined goals are satisfied given the current purchases. In one example, grocery items can be analyzed for their nutritional information at 806. In some embodiments, the nutrition information can be compared against projected nutritional characteristics for a period of time. In other embodiments, user goals can be segmented into periods of time and the segmented periods compared to the received health and wellness activity to determine if a current purchase or purchases satisfy goals.

For purchases that do not meet goals and even purchases that do meet goals, alternative purchases can be identified at 808 that improve goal characteristics either individually or in the aggregate. For analyzed items, equivalent items having improved characteristics can be retrieved from a database of products and nutritional information. In some embodiments, similar items can also be retrieved and analyzed to provide recommendations for purchases having improved nutritional characteristics. For example, searches can be executed against local databases storing product and nutrition information. Names of products received, can be searched to identify the same or similar products in the database. The returned results can be ranked by their nutritional characteristics, eliminating products that do not have characteristics that are as good or better than a what is in the user's current shopping cart. In other examples, any identifying information received on a user's purchases can be used as search criteria to automatically identify alternative products. In some embodiments, external systems can be queried to identify alternative products with improved nutritional characteristics. Alternatives can be delivered to the user as recommendations to modify the user's current purchase selections 810.

In some embodiments, recommendations can be delivered to a user in a user interface the user is viewing during their shopping activity. In other embodiments, recommendations can be delivered to computer devices associated with the user. For example, recommendations can be delivered to a user's smart phone, mobile computer, or other computer device.

In some embodiments, recommendations can be delivered on other properties 803 NO. For example, purchase information can evaluated for non-nutritional recommendations, including recommendations based on a user's profile. In one example, recommendations can include reminders or warnings regarding drug purchases delivered to the user. The user's profile information can identify medical conditions for a respective user. In some examples, past purchase information can be used to identify conditions, and/or the need for reminders to purchase medications. The medical conditions can require medications that are refilled on a schedule. Past purchase history and current purchase analysis can determine that a needed prescription has not been filled at 812. A reminder to purchase the medication can be generated at 814.

Process 800 can optionally continue at 808 with alternative analysis and identification of generic medicine alternatives, and/or dietary recommendation that have beneficial characteristics for a person with the medical condition. Reminders can be delivered to the users at 810.

In some embodiments, drug and/or food interactions can be identified based on evaluation of a user's purchases (both historic and current purchases) at 812. In some embodiments, evaluation of purchases at 812 can also include analysis of nutritional information for generating reminders or warnings on drug interactions or adverse indications for drug/food interactions. For example, warnings for a user having a high blood pressure condition can be generated at 814 based on grocery purchases having high salt content. Alternative purchases selections can be identified at 808 with lower salt content, and the warning and alternatives can be communicated to the user at 810.

Various embodiments may be implemented on one or more specially programmed general purpose computer systems, including for example systems 100, 150, and 160 in FIGS. 1A-D. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor, including multi-core processors. It should be appreciated that one or more of any type computer system may be used to facilitate generating and delivering health and wellness recommendations according to various embodiments of the invention. Further, the computer system for generating and delivering health and wellness recommendations may be located on a single computer or may be distributed among a plurality of computers attached by a communications network.

A general-purpose computer system according to one embodiment of the invention is specially configured to perform any one or more of the described functions, including but not limited to, creating, storing, parsing, matching, evaluating, and displaying health and wellness recommendations based on defined goals or other health and wellness criteria, as well as monitoring and analyzing any health and wellness data, including users purchase activity made on-line or off-line at real world stores, etc., and the invention is not limited to having any particular function or set of functions.

FIG. 9 shows a block diagram of a general purpose computer and network system 900 in which various aspects of the present invention may be practiced. For example, various aspects of the invention may be implemented as specialized software executing in one or more computer systems including general-purpose computer systems, 902-906, shown in FIG. 9. Various embodiments of a health and wellness platform can be implemented on general purpose computer systems (e.g., 902 and/or 904-906). Computer system 902 may include a processor 916 connected to one or more memory devices 914, such as a disk drive, memory, or other devices for storing data. Memory 914 is typically used for storing programs and data during operation of the computer system. Components of computer system 902 may be coupled by an interconnection mechanism such as network 908, which may include one or more busses (e.g., between components that are integrated within a same machine) and/or a network 910 (e.g., between components that reside on separate discrete machines). The interconnection mechanism enables communications (e.g., data, instructions) to be exchanged between system components of the system.

Computer system 902 also includes one or more input/output (I/O) devices 912, for example, a keyboard, mouse, trackball, microphone, touch screen, a printing device, display screen (e.g., 922), speaker, etc. In addition, computer system may contain one or more interfaces (e.g., network communication device 920) that connect computer system to a communication network 908 (in addition or as an alternative to the network 910).

The storage system, typically includes a computer readable and writeable nonvolatile recording medium in which signals are stored that define a program to be executed by the processor or information stored on or in the medium to be processed by the program. The medium may, for example, be a disk or flash memory. Typically, in operation, the processor 916 causes data to be read from the nonvolatile recording medium into another memory that allows for faster access to the information by the processor than does the medium. This memory is typically a volatile, random access memory such as a dynamic random access memory (DRAM) or static memory (SRAM). The memory may be located in storage system 918, as shown, or in memory system 914. The processor 916 generally manipulates the data within the memory 914, and then copies the data to the medium associated with storage after processing is completed. A variety of mechanisms are known for managing data movement between the medium and integrated circuit memory and the invention is not limited thereto. The invention is not limited to a particular memory system 914 or storage system 916.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent system component (e.g., goal component, monitor component, recommendation component, visualization component, registration component, and analysis component).

Although the computer system of FIG. 9 is shown by way of example as one type of computer system upon which various aspects of the invention may be practiced, it should be appreciated that aspects of the invention are not limited to being implemented on the computer system as shown. Various aspects of the invention may be practiced on one or more computers having a different architectures or components that that shown in FIG. 9. The computer system can execute the processes flows illustrated for example FIGS. 2-8, and/or components of a health and wellness platform system (e.g., platform 100, 150, and 160) can be also configured to execute any of the processes or parts of process flows illustrated in FIGS. 2-8. The processes can also include other processes, sub-processes, and may be executed in conjunction.

The computer system 902 may be a general-purpose computer system that is programmable using a high-level computer programming language. The computer system may be also implemented using specially programmed, special purpose hardware. In the computer system, processor is typically a commercially available processor such as the well-known Pentium class processor available from the Intel Corporation. Many other processors are available including multi-core processors and microprocessors. Such a processor usually executes an operating system which may be, for example, the Windows-based operating systems (e.g., Windows NT, Windows 2000 (Windows ME), Windows XP, Windows VISTA, Windows 7 operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention, for example, system components, may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention including monitoring, defining, accessing, and evaluating a user's purchase activity, generating health and wellness recommendations, creating and displaying user avatars, as examples. Other system components can be configured to monitor a user's shopping activity, connect to external shopping systems, access nutrition characteristics, register users, identify shopping accounts, reward membership account, define goals, project shopping activities, model shopping activity, etc. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this system can be implemented by one or more systems within the computer system 902. For instance, a health and wellness platform may be configured as a distributed system (e.g., client server, multi-tier system). In one example, the health and wellness platform includes software processes executing on a system associated with a user (e.g., a client system). These systems may permit the user to register for a health and wellness platform, input demographic information, input medical conditions, input user profile information, identify shopping sites, identify reward memberships, social networking sites, identify other external sources of user purchase information, etc. Further, client systems can be associated with registered users who access, for example, a health and wellness platform to received health and wellness recommendations for purchase activity.

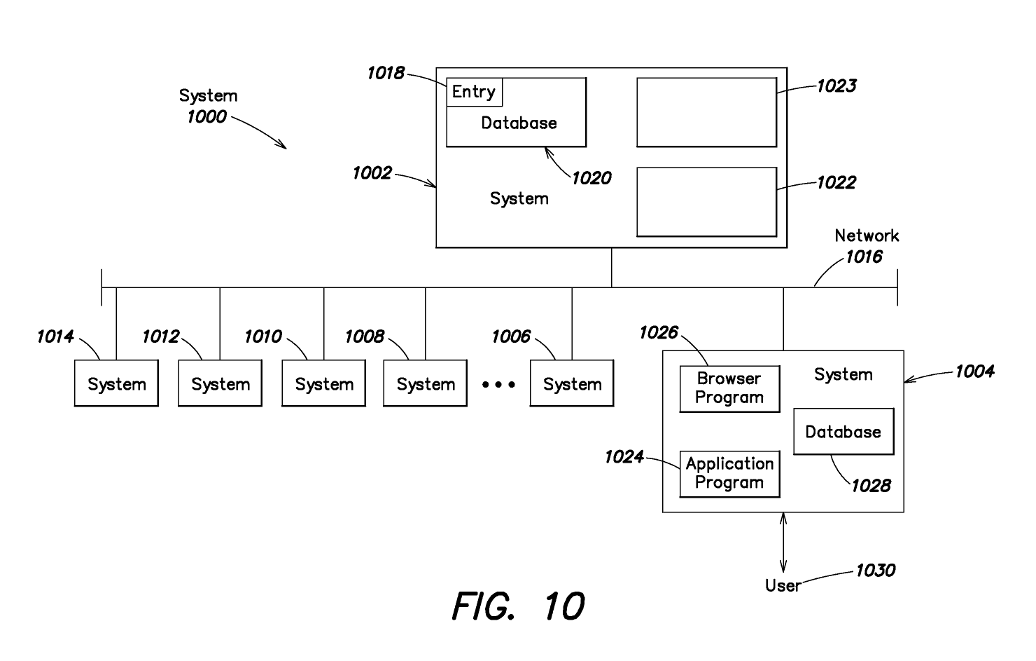

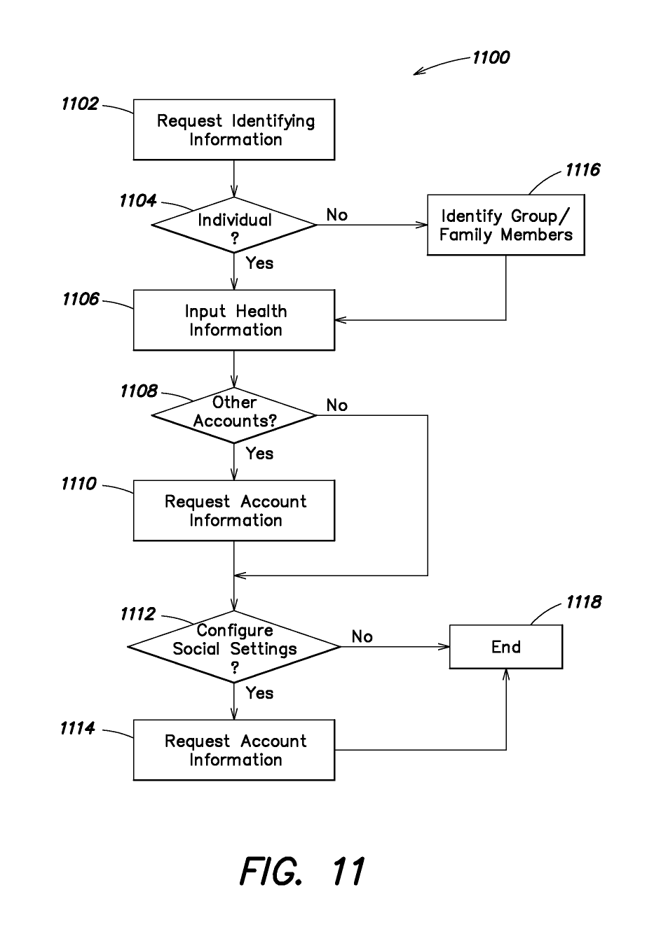

FIG. 10 shows an architecture diagram of an example system according to one embodiment of the invention. It should be appreciated that FIG. 10 is used for illustration purposes only, and that other architectures may be used to facilitate one or more aspects of the present invention.

As shown in FIG. 10, a distributed system 1000 can be composed of a plurality of general purpose computer system (e.g., 1002-1014) specially configured to conduct functions of a health and wellness platform, including, but not limited to, monitoring, and evaluation of health and wellness activity, generation of recommendations for alternative purchases, supplemental purchases, etc. The distributed system may include one or more general purpose computer systems (e.g., 1002-1014) coupled by a communication network 1016. Such computer systems may be, for example, general-purpose computer systems as discussed above with reference to FIG. 9.

In one embodiment of the present invention, a system 1002 stores attributes associated with nutritional characteristics of grocery items, medical information associated with medications, historical purchases for a user, statistical models for purchase activity, collects information from external accounts, provide browser processes for accessing shopping sites, etc. Each register user can be associated with an entry 1018 in the database 1020, additional entries can store information associated with each user, for example, any purchase activity can be stored in association with a respective user, etc. Various embodiments can employ databases organized by record, although other database models can be used to store information. In some examples, a relational database model is implemented, and in others non-relational database models can be employed.

Further, the system 1002 performs functions associated with the displaying and modification of user avatars based on goal performance, and other functions associated with defining and classifying user goals, extrapolating goals into measureable characteristics, and evaluating current purchase activity against goals. The system 1002 can also be configured to access nutrition information associated with grocery purchases, access medical condition information associated with drug prescriptions, evaluate general merchandise for health and wellness benefits, determine how well a user is meeting or will meet any established goals, generate recommendations based on health and wellness goals, medical conditions, or other criteria. In some embodiments, system 1002 can also be configured to instantiate and execute system components (e.g., goal component, registration component, analysis component, visualization component, monitor component, and recommendation component) for monitoring and delivering health and wellness recommendations. The various components can be configured to perform the functions and/or operations, execute the processes, in whole or in part, as discussed above.

The system 1002 may include a server process 1022 and/or program 1023 that responds to requests from one or more client programs. Process 1022 may include, for example, an HTTP server or other server-based process (e.g., a database server process, XML server, peer-to-peer process) that interfaces to one or more client programs distributed among one or more client systems, for example 1010-1014, to provide access to users and/or deliver health and wellness recommendations to the user during, for example, on-line purchase activity.

According to one embodiment, client programs 1024 may be capable of permitting a user 1030 to register for and receive recommendations from a health and wellness platform. Such client programs may include, for example, any type of operating system and/or application program capable of communicating with the system 1002 through a network. In one particular instance, a client system 1004 may include a browser program (e.g., browser program 1026) that communicates with the server process 1022 or program 1023 using one or more communication protocols (e.g., HTTP over a TCP/IP-based network, XML requests using HTTP through an Ajax client process, distributed objects, https, or other secure or non-secure communication protocol).

In some settings, the health and wellness platform implemented on system 1002 can include locally executable components that can monitor on-line shopping activity as it takes place on system 1004. In some embodiments, the health and wellness platform can be configured to capture data from shopping activity being performed on system 1004 based on execution of the locally executable component(s) during shopping activity on 1002. In some examples, a user 1030 can download and install the locally executable components on system 1004. In other examples, system 1002 can be configured to automatically transmit the locally executable component(s) to a user system, e.g., 1004.

Although it is shown by way of example that a browser program 1026 may be used to access the health and wellness platform, manage user profiles, register for a user for a health and wellness platform, defined user avatars, it should be appreciated that other program types may be used. The client program may be, for example, a thin client including an interface for accessing a health and wellness platform, accessing shopping sites, and receive health and wellness recommendations. Alternatively, the client may be a scripted program, or any other type of program having the capability of transferring data from, for example, a database 1028. According to one embodiment, such client programs may, for example, be downloaded and installed over the network. Further, these client programs may be stored and distributed by system 1002 in the form of one or more software programs, including for example, browser plug-ins, active x objects, applets, and java code.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “containing”, “characterized by” and the like are to be understood to be open-ended, i.e., to mean including but not limited to. Only the transitional phrases “consisting of” and “consisting essentially of” respectively, shall be closed or semi-closed transitional phrases, as set forth, with respect to claims, in the United States Patent Office Manual of Patent Examining Procedures (Eighth Edition 2nd Revision, May 2004), Section 2111.03.

Use of ordinal terms such as “first”, “second”, “third”, “a”, “b” “c” etc., in the claims to modify or otherwise identify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system for delivering health and wellness recommendations, the system comprising at least one processor operatively connected to a memory, the processor configured to execute a plurality of system components, the plurality of system components comprising:
a goal component configured to establish health related goals for a user;
a monitor component configured to monitor shopping activity for the user;
a recommendation component configured to generate recommendations for purchase items based, at least in part, on analysis of the shopping activity and the health related goals; and
a communication component configured to communicate the recommendations to the user, wherein at least some of the recommendations are communicated during an on-line shopping activity of the user.

2. The system according to claim 1, wherein the plurality of system components further comprises a visualization component configured to define an avatar for the user.

3. The system according to claim 2, wherein the visualization component is further configured to modify the avatar based, at least in part, on monitored activity associated with the health related goals.

4. The system according to claim 3, wherein the visualization component is further configured to publish the avatar.

5. The system according to claim 1, wherein the plurality of system components further comprises a user interface component configured to accept information on at least one user, including account information for on-line shopping accounts.

6. The system according to claim 5, wherein the on-line shopping accounts include at least one of an on-line grocery system, an on-line pharmacy system, and an on-line general merchandise system.

7. The system according to claim 1, wherein the plurality of system components further comprises an analysis component configured to analyze the monitored activity to determine health and wellness performance.

8. The system according to claim 7, wherein the analysis component is further configured to determine health and wellness performance based on comparing user purchases to a statistical model for expected purchases.

9. The system according to claim 1, wherein the recommendation component is further configured to generate at least one alternative purchase selection based on the analyzed nutrition characteristics.

10. The system according to claim 1, wherein the recommendation component is further configured to generate at least one alternative purchase selection based on a user profile.

11. A computer implemented method for delivering health and wellness recommendations, the method comprising:
establishing, using a computer system, health related goals for a user;
monitoring, using the computer system, shopping activity for the user;
generating, by the computer system, recommendations for purchase items based, at least in part, on analysis of the shopping activity and the health related goals; and
communicating, by the computer system, the recommendations to the user, wherein at least some of the recommendations are communicated during an on-line shopping activity of the user.

12. The method according to claim 11, further comprising an act of establishing an avatar for the user for display on a user interface.

13. The method according to claim 12, further comprising an act of modifying the avatar based, at least in part, on monitored activity associated with the health related goals.

14. The method according to claim 13, further comprising an act of publishing the avatar.

15. The method according to claim 11, further comprising an act of accepting information on at least one user, including account information for on-line shopping accounts.

16. The method according to claim 15, wherein the on-line shopping accounts include at least one of an on-line grocery system, an on-line pharmacy system, and an on-line general merchandise system.

17. The method according to claim 11, further comprising an act of analyzing the monitored activity to determine health and wellness performance.

18. The method according to claim 17, further comprising an act of determining health and wellness performance based on comparing user purchases to a statistical model for expected purchases.

19. The method according to claim 11, further comprising an act of generating at least one alternative purchase selection based on analyzed nutrition characteristics of the purchases.

20. The method according to claim 11, further comprising an act of generating at least one alternative purchase selection based on a user profile.
